(19) United States
(12) Patent Application Publication
(10) Pub. No.: US 2006/0250111 A1
(43) Pub. Date: Nov. 9, 2006

(54) Multipurpose electric appliance control circuit assembly

(76) Inventor: Jen-Yen Yen, Yenpu Hsiang (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/122,079

(22) Filed: May 5, 2005

(51) Int. Cl. H02J 7/00

(52) U.S. Cl. 320/115

(57) ABSTRACT

A multipurpose electric appliance control circuit assembly includes a hand-driven dynamo rotatably driven by hand to generate AC power supply, a rechargeable battery, a rectifier filter circuit for rectifying AC power supply from the hand-driven dynamo into DC power supply and filtering noise from the DC power supply for charging the rechargeable battery. The control circuit assembly also includes a lighting circuit electrically connected to the rechargeable battery for emitting light for illumination subject to the control of a switch, a boosting circuit for boosting the voltage of the rechargeable battery to a predetermined voltage level, and a power output circuit for selectively dropping the boosted DC voltage to one of a series of voltage levels for different electric appliances.

### BACKGROUND OF THE INVENTION

1. Field of the Invention

The present invention relates to an electric appliance control circuit assembly and more particularly, to a multipurpose electric appliance control circuit assembly, which can be controlled to emit light for illumination, or to receive broadcast signals from radio stations.

2. Description of the Related Art

A mobile lighting apparatus is known using a hand-driven dynamo to provide AC power supply, and a rectifier circuit to rectify AC power supply into DC power supply for charging a rechargeable battery to provide the necessary working voltage to a light emitting device for giving off light. This apparatus can be used for illumination only.

Further, there are AC to DC power adapters capable of rectifying AC power supply into different DC voltages for different electric appliances. These AC to DC power adapters can only be used to rectify city power supply into DC power supply. If city power supply is not available, these AC to DC power adapters become useless.

### SUMMARY OF THE INVENTION

The present invention has been accomplished under the circumstances in view. It is one object of the present invention to provide a multipurpose electric appliance control circuit assembly, which can be controlled to emit light for illumination, or to receive broadcast signals from radio stations. It is another object of the present invention to provide a multipurpose electric appliance control circuit assembly, which can be operated manually to provide the necessary working voltage. It is still another object of the present invention to provide a multipurpose electric appliance control circuit, which can be controlled to output different voltages for different electric appliances. To achieve these and other objects of the present invention, the multipurpose electric appliance control circuit assembly comprises a hand-driven dynamo rotatably by hand to generate AC power supply, a rechargeable battery, a rectifier filter circuit for rectifying AC power supply from the hand-driven dynamo into DC power supply and to filtrating noises from the DC power supply for charging the rechargeable battery, a lighting circuit electrically connected to the rechargeable battery for emitting light for illumination subject to the control of a switch, a boosting circuit for boosting the voltage of the rechargeable battery to a predetermined voltage level, a power output for selectively dropping the boosted DC voltage to one of a series of voltage levels for different electric appliances.

### BRIEF DESCRIPTION OF THE DRAWINGS

FIG. 1 is circuit diagram of the present invention.

FIG. 2 is a system block diagram of the present invention.

### DETAILED DESCRIPTION OF THE PREFERRED EMBODIMENT

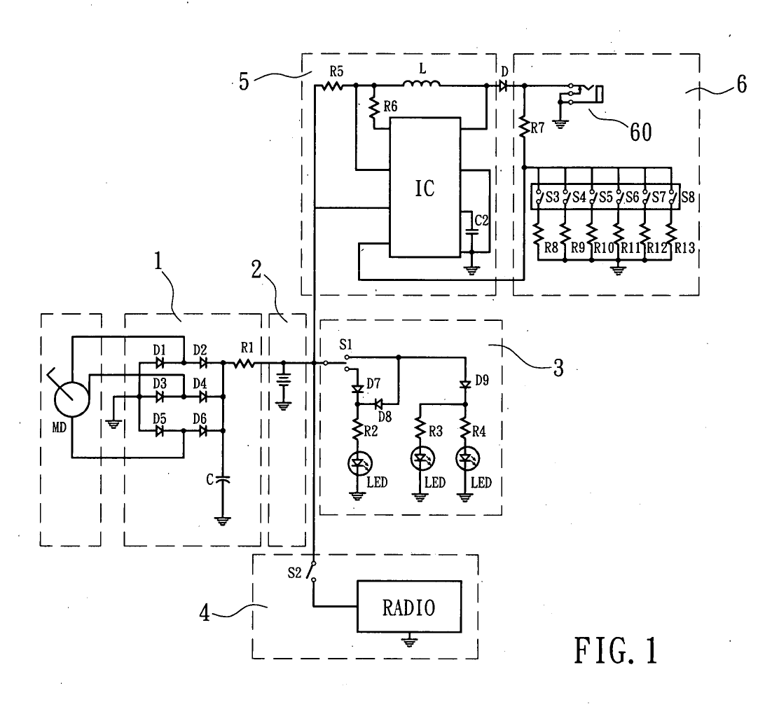

Referring to FIG. 1, a multipurpose electronic appliance control circuit assembly in accordance with the present invention is shown mounted inside a housing and comprised of a hand-driven dynamo MD, a rectifier filter circuit 1, a rechargeable battery 2, a lighting circuit 3, a boosting circuit 5, a power output circuit 6, and a radio 4.

The hand-driven dynamo MD is rotatably by hand to generate AC power supply.

The rectifier filter circuit 1 is comprised of a plurality of diodes D1,D2,D4,D5,D6, a resistor R1, and a capacitor C1, and adapted to rectify AC power supply generated by the hand-driven dynamo MD into DC power supply and to filtrate noises from rectified DC power supply, so as to provide stabilized voltage to charge the rechargeable 2.

The lighting circuit 3 is comprised of a plurality of diodes D7,D8,D9, a plurality of resistors R2,R3,R4, a light emitting diode LED, and a switch S1. The switch S1 is electrically connected to the rechargeable battery 2 to control output of battery power supply from the rechargeable battery 3 to the light emitting diode LED, causing the light emitting diode LED to give off light for illumination.

The boosting circuit 5 is electrically connected to the rechargeable battery 2 and adapted to boost the voltage of the battery DC power supply to a predetermined voltage level, comprised of a boosting chip IC, resistors R5,R6, an inductor L, and a capacitor C2.

The power output circuit 6 is comprised of a resistor R7, an electric socket 60, and a series circuit, which is comprised of resistors of different resistance values R8,R9,R10,R11,R12,R13, and switches S3,S4,S5,S6,S7,S8. The power output circuit 6 is electrically connected to the boosting circuit 5 to drop the voltage of the output power from the boosting circuit 5 to different voltage levels such as 3V, 4.5V, 5V, 6V, 7.5V, 9V, 12V for output through the electric socket 60 subject to the control of the switches S3,S4,S5,S6,S7,S8.

The radio 4 is adapted to receive broadcast signal from a radio station, enable the user to enjoy the audio program of the radio station.

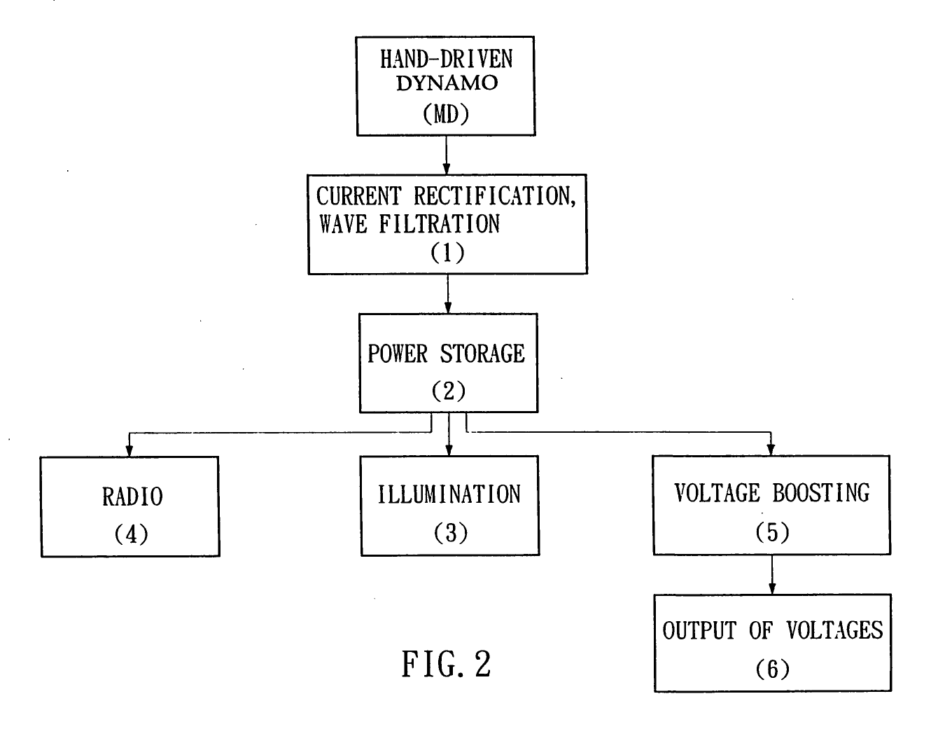

Referring to FIG. 2, when the user rotates the internal rotor of the hand-driven dynamo MD, the hand-driven dynamo MD generates AC power supply (of voltage about 6V), which is then rectified by the diodes D1,D2,D3,D4,D5,D6 into DC power supply, and then filtrated through the capacitor C1 and stabilized by the resistor R1 (to the voltage level about 4.2V) for charging the rechargeable battery 2 to the saturated status.

When the switch S1 of the lighting circuit 3 is switched on, battery power supply is transmitted from the rechargeable battery 2 to the lighting circuit 3, thereby causing the light emitting diode LED to give off light for illumination. When the switch S2 of the radio 4 is switched on, battery power supply is transmitted from the rechargeable battery 2 to the radio 4, enabling the radio 4 to receive broadcast signal from a radio station and to output received broadcast signal through speaker means thereof (Because the circuit design of the radio is of the known art and not within the scope of the present invention, no detailed description in this regard is necessary). Further, because the rechargeable battery 2 is electrically connected to the boosting circuit 5, the boosting circuit 5 boosts the voltage (about 4.2) of the rechargeable battery 2 to a predetermined voltage level (for example, about 15V) for output through the power output circuit 6, which drops the voltage to one of a series of voltage levels (for example, 3V, 4.5V, 6V, 7.5V, 9V, 12V subject to the control of the resistors R8,R9,R10,R11,R12,R3. Therefore, the power output circuit 6 provides different voltages for different electric appliances, i.e., any of a variety of electric appliances such as digital camera, mobile computer, digital video player, mobile telephone, pal-top game machine, etc., can be connected to the electric socket 60 to obtain the necessary working voltage subject to the control of the switch S3, S4, S5, S6, S7 or S8.

As indicated above, the invention uses a hand-driven dynamo MD and a rechargeable battery 2 to provide DC power supply for any of a variety of electric appliances. The invention can also be used as an electric hand light as well as a radio to receive audio programs from radio stations.

Although a particular embodiment of the invention has been described in detail for purposes of illustration, various modifications and enhancements may be made without departing from the spirit and scope of the invention.

1. A multipurpose electric appliance control circuit assembly comprising:
a housing:
a hand-driven dynamo rotatable by hand to generate AC power supply disposed within said housing;
a rechargeable battery disposed with said dynamo within said housing to be rechargeable responsive thereto;
a rectifier filter circuit disposed within said housing and adapted to rectify AC power supply from said hand-driven dynamo into DC power supply and to filter noises from the DC power supply for charging said rechargeable battery, said rectifier filter circuit including a plurality of diodes, a resistor, and a capacitor; and,
a plurality of units concurrently coupled in selectively operable manner to said rechargeable battery, said units including:
a lighting circuit disposed within said housing and electrically connected in a selectively operable manner to said rechargeable battery to be powered thereby and adapted to emit light to an environment external to said
